(19) United States
(12) Patent Application Publication
(10) Pub. No.: US 2025/0063597 A1
(43) Pub. Date: Feb. 20, 2025

(54) Reception-Condition based Selective Puncturing

(71) Applicant: Telefonaktiebolaget LM Ericsson (publ), Stockholm (SE)

(72) Inventors: Abhishek Ambede, Huddinge (SE); Leif Wilhelmsson, Lund (SE); Rocco Di Taranto, Lund (SE)

(21) Appl. No.: 18/717,774

(22) PCT Filed: Dec. 23, 2021
(86) PCT No.: PCT/EP2021/087547

§ 371 Date: Jun. 7, 2024

(51) Int. Cl. H04W 74/0816; H04B 17/318; H04L 1/00; H04W 74/00

(52) U.S. Cl. CPC H04W 74/0816; H04B 17/318; H04L 1/0003; H04L 1/0068; H04W 74/002

(57) ABSTRACT

A wireless communication device (10, 11) determines an idle bandwidth portion of a wireless channel. Further, the wireless communication device (10, 11) estimates one or more reception conditions at a further wireless communication device (10, 11). Using a transmission bandwidth in the idle bandwidth portion of the wireless channel, the wireless communication device (10, 11) sends a wireless data transmission to the further wireless communication device (10, 11). The transmission bandwidth of the wireless data transmission is selectively punctured based on the estimated one or more reception conditions.

### TECHNICAL FIELD

The present invention relates to methods for controlling wireless transmissions and to corresponding devices, systems, and computer programs.

### BACKGROUND

In wireless communication technologies, there is an increased interest in using unlicensed bands, like the 2.4 GHz ISM band, the 5 GHz band, the 6 GHz band, and the 60 GHz band using more advanced channel access technologies. While operating in such license-exempt spectrum, wideband wireless communication systems like WLAN (Wireless Local Area Network) systems, also referred to as Wi-Fi systems, are typically required to operate using a listen before talk (LBT) mechanism, sometimes also referred to as CCA (Clear Channel Assessment) or CSMA/CA (Carrier Sense Multiple Access with Collision Avoidance). In an LBT or CSMA/CA mechanism, before a transmission can be initiated, a transmitter listens on the wireless medium to determine whether a wireless channel is idle or busy. This may for example be based on sensing received energy on the wireless channel. If the wireless channel is found to be idle, i.e., not in use by some other transmitting device, the transmitter can initiate the transmission, typically using a random channel access mechanism. If the wireless channel is found to be busy, i.e., in use by some other transmitting device, the transmitter defers from transmission and typically continues sensing the wireless channel until the wireless channel is found to be idle.

In wireless communication systems according to “IEEE Standard for Information Technology—Telecommunications and Information Exchange between Systems-Local and Metropolitan Area Networks—Specific Requirements-Part 11: Wireless LAN Medium Access Control (MAC) and Physical Layer (PHY) Specifications,” in IEEE Std 802.11-2020 (Revision of IEEE Std 802.11-2016), pp. 1-4379, 26 Feb. 2021, in the following denoted as “IEEE 802.11 Standard”, different carrier sensing mechanisms are supported that can help stations (STAs) to assess and identify the idle and/or busy portions of their operating bandwidths.

One carrier sensing mechanism supported in the IEEE 802.11 Standard is CCA using an energy detection (ED) threshold. This mechanism may be regarded as the most basic physical layer (PHY) carrier sensing mechanism and is useful to detect and protect against various types of interferers. In this carrier sensing mechanism for carrier sensing, a STA is required to defer its transmissions over the channel as long as the energy it senses over the channel is at or above the ED threshold. A typical value of ED threshold for a 20 MHz channel is-62 dBm in the 2.4 GHz and 5 GHz frequency bands. The value of the ED threshold is based on regulations and may differ for channels in different frequency bands. The CCA frequency granularity defined by the IEEE 802.11 Standard is 20 MHz, i.e., the wireless medium is detected to be idle or busy over frequency ranges of 20 MHz.

Another example of carrier sensing mechanism supported by the IEEE 802.11 Standard is virtual carrier sensing using network allocation vector (NAV). Virtual carrier sensing using NAV is a medium access control (MAC) layer mechanism, and it relies on information carried in a Duration field of the MAC headers of successfully decoded frames that are detected at or above the receiver sensitivity level. The Duration field carries information about impending use of the medium, and the STAs must defer from transmitting until end of the time indicated by the Duration field. The NAV may be regarded as an indicator, maintained by each STA, of time periods when transmission onto the wireless medium should not be initiated by the STA regardless of whether the STA's CCA function assesses the medium to be busy or idle. It should be noted that a STA is mandated to set its NAV only if the detected and decoded frame includes the primary 20 MHz subchannel of the operating bandwidth of that STA. Another important point to note is that the IEEE 802.11 Standard does not dictate how a STA should behave below the minimum receiver sensitivity level that is mandated by the standard. Thus, if a valid IEEE 802.11 frame is detected by a STA at a level below-82 dBm for a 20 MHz channel, the STA is not required to set its NAV. Also, it can be noted that the virtual NAV mechanism is useful to detect and protect against Wi-Fi interferers only, thereby helping different Wi-Fi networks to co-exist with one another.

A still further example of carrier sensing mechanism supported by the IEEE 802.11 Standard is CCA using preamble detection (PD) threshold. CCA using PD threshold This is another PHY mechanism. In this carrier sensing mechanism, if a STA detects the start of a signal with a valid IEEE 802.11 preamble at a value at or above the PD threshold in a particular channel, the STA is required to defer its transmissions over that channel for a duration corresponding to the frame length value that is included in the preamble. A typical value of PD threshold for a 20 MHz channel is-82 dBm in the 2.4 GHz and 5 GHz frequency bands. The value of the PD threshold may differ for channels in different frequency bands.

The IEEE 802.11ax technology, see “IEEE 802.11ax-2021-IEEE Standard for Information technology-Telecommunications and information exchange between systems Local and metropolitan area networks-Specific requirements Part 11: Wireless LAN Medium Access Control (MAC) and Physical Layer (PHY) Specifications Amendment 1: Enhancements for High Efficiency WLAN” in IEEE Std 802.11ax-2021 (Amendment to IEEE Std 802.11-2020), pp. 1-767, 19 May 2021, also denoted as “IEEE 802.11ax amendment” or High Efficiency (HE) amendment, supports usage of different PD thresholds for primary and non-primary 20 MHZ subchannels to encourage spatial reuse among neighboring basic service sets (BSSs) when they operate using partially or completely overlapping channels. Correspondingly, the PD thresholds for non-primary 20 MHz subchannels may be relaxed compared to the PD threshold used for the primary 20 MHz subchannel. Similar to the CCA mechanism using ED threshold, this mechanism operates independently for every 20 MHz subchannel in the operating bandwidth of a STA.

The STAs, including access points (APs) and non-AP STAs, can use the above carrier sensing mechanisms determining an allowed transmission bandwidth. Further, the IEEE 802.11 Standard supports features enabling a transmitter to adapt its data frame transmission bandwidth in a dynamic fashion. For example, an optional control frame exchange protocol involving request-to-send (RTS) and clear-to-send (CTS) frames can be used by a transmitting (TX) STA immediately prior to transmitting a data frame or a burst of data frames to one or more intended receiving (RX) STAs. The RTS/CTS protocol can be used for ensuring that the one or more RX STAs are alert and ready for reception, and for knowing the available reception bandwidth at the intended RX STA(s), i.e., the portions of the operating bandwidth assessed by the carrier sensing mechanisms of the intended receiver as being idle. Further, the RTS and CTS frames may be used to reserve and protect a transmit opportunity (TXOP) and to prevent hidden node related interference by setting the NAVs at all neighboring STAs belonging to the same BSS that are not intended receivers as well as STAs belonging to any overlapping BSSs (OBSSs).

In a basic RTS/CTS frame exchange, a TX STA first transmits a RTS frame using the full channel bandwidth over which it gains channel access and intends to undertake the subsequent data frame transmission(s). The RTS frame is typically duplicated over every 20 MHz subchannel. This channel bandwidth is also indicated in the RTS frame and may be denoted as intended transmission bandwidth. Upon receiving the RTS frame, an intended RX STA checks the status of the CCA for every 20 MHz subchannel of the intended transmission bandwidth and also checks the status of the NAV. If the status of NAV is idle and the CCA per 20 MHz subchannel indicates that none of the 20 MHz subchannels is busy, the RX STA responds with a CTS frame using the full intended transmission bandwidth. Similar to the RTS frame, the CTS frame is also duplicated over every 20 MHz subchannel. The same channel bandwidth is also indicated in the CTS frame and may be denoted as available reception bandwidth. If the RX STA does not respond with a CTS frame, the TX STA cannot perform its data frame transmission(s).

In a more flexible version of the RTS/CTS frame exchange related to dynamic bandwidth operation introduced in the IEEE 802.11ac technology, see “IEEE Standard for Information technology—Telecommunications and information exchange between systems Local and metropolitan area networks—Specific requirements—Part 11: Wireless LAN Medium Access Control (MAC) and Physical Layer (PHY) Specifications—Amendment 4: Enhancements for Very High Throughput for Operation in Bands below 6 GHz.,” in IEEE Std 802.11ac-2013 (Amendment to IEEE Std 802.11-2012), pp. 1-425, 18 Dec. 2013, also denoted as “IEEE 802.11ac amendment” or Very High Throughput (VHT) amendment, the TX STA may indicate in the RTS frame that it supports dynamic bandwidth operation. Then an intended RX STA has some flexibility when responding with a CTS frame: The RX STA can transmit a CTS frame using only the channel bandwidth that is assessed as being idle based on the status of NAV, CCA and channel bonding rules.

Channel Bonding was introduced in the IEEE 802.11n technology, see “IEEE Standard for Information technology—Local and metropolitan area networks—Specific requirements—Part 11: Wireless LAN Medium Access Control (MAC) and Physical Layer (PHY) Specifications Amendment 5: Enhancements for Higher Throughput,” in IEEE Std 802.11n-2009 (Amendment to IEEE Std 802.11-2007), pp. 1-565, 29 Oct. 2009, also denoted as “IEEE 802.11n amendment” or High Throughput (HT) amendment. Channel bonding allows a STA to cascade adjacent subchannels to increase the transmission bandwidth. When the TX STA performs carrier sensing for attempting a transmission over the wireless medium, the allowed transmission bandwidth is determined by first assessing whether the primary 20 MHZ subchannel of the operating bandwidth is idle and then assessing and appropriately cascading the non-primary subchannels. For example, a 80 MHz transmission may be composed of one primary 40 MHZ subchannel transmission and one secondary 40 MHZ subchannel transmission. The primary 40 MHz subchannel itself is in turn composed of one primary 20 MHz subchannel and one secondary 20 MHz subchannel.

When using the RTS/CTS frame exchange together with dynamic bandwidth operation, the indicated available reception bandwidth can be the same as or smaller than the intended transmission bandwidth. If the full intended transmission bandwidth is not assessed as being idle by the RX STA, the dynamic bandwidth operation can allow the transmitter to undertake the data frame transmission(s) at least over the indicated available reception bandwidth.

A further feature introduced in the HE amendment is preamble puncturing. Preamble puncturing allows a STA to transmit or receive a PHY protocol data unit (PPDU) over a channel even when a portion of the channel bandwidth is not occupied by that transmitted or received PPDU. In other words, the corresponding portion of the bandwidth of the entire PPDU is left empty, including the preamble as well as data fields.

In IEEE contributions “RTS/CTS frames in 11be” (https://mentor.ieee.org/802.11/dcn/20/11-20-0747-00-00be-rts-cts-in-11be.pptx, January 2020) and “BW Negotiation, TXOP Protection with >160 MHz PPDU and Puncture Operation” (https://mentor.ieee.org/802.11/dcn/20/11-20-0062-00-00be-protection-with-more-than-160 mhz-ppdu-and-puncture-operation.pptx, January 2020) it is proposed to design enhanced RTS/CTS frames with a channel puncturing bitmap having 20 MHz resolution in order to provide channel puncture information. Thus, as compared to just using the dynamic bandwidth operation, allowed transmission bandwidth of data frames could be further increased.

When the transmission bandwidth selected by a transmitter is based on what parts of the spectrum is assessed as being idle, the resulting performance may still be unsatisfactory. For example, when utilizing a rather large idle bandwidth, poor channel conditions in parts of that idle bandwidth may result in lower overall performance as compared to a case when using only a smaller transmission bandwidth. So maximizing the transmission bandwidth based on the detected idle parts of the overall available bandwidth is not necessarily the best choice in view of overall performance.

Accordingly, there is a need for techniques which allow for efficiently controlling wireless transmissions depending on an idle portion of the available transmission bandwidth.

### SUMMARY

According to an embodiment, a method of controlling wireless transmissions in a wireless communication system is provided. According to the method, a wireless communication device determines one or more idle bandwidth portions of a wireless channel. Further, the wireless communication device estimates one or more reception conditions at a further wireless communication device. Using a transmission bandwidth in the one or more idle bandwidth portions of the wireless channel, the wireless communication device sends a wireless data transmission to the further wireless communication device. The transmission bandwidth of the wireless data transmission is selectively punctured based on the estimated one or more reception conditions.

According to an embodiment, a method of controlling wireless transmissions in a wireless communication system is provided. According to the method, a wireless communication device determines one or more idle bandwidth portions of a wireless channel. Using a transmission bandwidth in the one or more idle bandwidth portions of the wireless channel, the wireless communication device receives a wireless data transmission from a further wireless communication device. The transmission bandwidth of the wireless data transmission is selectively punctured based on one or more reception conditions at the wireless communication device.

According to a further embodiment, a wireless communication device for a wireless communication system is provided. The wireless communication device is configured to determine one or more idle bandwidth portions of a wireless channel. Further, the wireless communication device is configured to estimate one or more reception conditions at a further wireless communication device. Further, the wireless communication device is configured to, using a transmission bandwidth in the one or more idle bandwidth portions of the wireless channel, send a wireless data transmission to the further wireless communication device. The transmission bandwidth of the wireless data transmission is selectively punctured based on the estimated one or more reception conditions.

According to a further embodiment, a wireless communication device for a wireless communication system is provided. The wireless communication device comprises at least one processor and a memory. The memory contains instructions executable by said at least one processor, whereby the wireless communication device is operative to determine one or more idle bandwidth portions of a wireless channel. Further, the memory contains instructions executable by said at least one processor, whereby the wireless communication device is operative to estimate one or more reception conditions at a further wireless communication device. Further, the memory contains instructions executable by said at least one processor, whereby the wireless communication device is operative to, using a transmission bandwidth in the one or more idle bandwidth portions of the wireless channel, send a wireless data transmission to the further wireless communication device. The transmission bandwidth of the wireless data transmission is selectively punctured based on the estimated one or more reception conditions.

According to a further embodiment, a wireless communication device for a wireless communication system is provided. The wireless communication device is configured to determine one or more idle bandwidth portions of a wireless channel. Further, the wireless communication device is configured to, using a transmission bandwidth in the one or more idle bandwidth portions of the wireless channel, receive a wireless data transmission from a further wireless communication device. The transmission bandwidth of the wireless data transmission is selectively punctured based on one or more reception conditions at the wireless communication device.

According to a further embodiment, a wireless communication device for a wireless communication system is provided. The wireless communication device comprises at least one processor and a memory. The memory contains instructions executable by said at least one processor, whereby the wireless communication device is operative to determine one or more idle bandwidth portions of a wireless channel. Further, memory contains instructions executable by said at least one processor, whereby the wireless communication device is operative to, using a transmission bandwidth in the one or more idle bandwidth portions of the wireless channel, receive a wireless data transmission from a further wireless communication device. The transmission bandwidth of the wireless data transmission is selectively punctured based on one or more reception conditions at the wireless communication device.

According to a further embodiment, a computer program or computer program product is provided, e.g., in the form of a non-transitory storage medium, which comprises program code to be executed by at least one processor of a wireless communication device is provided. Execution of the program code causes the wireless communication device to determine one or more idle bandwidth portions of a wireless channel. Further, execution of the program code causes the wireless communication device to estimate one or more reception conditions at a further wireless communication device. Further, execution of the program code causes the wireless communication device to, using a transmission bandwidth in the one or more idle bandwidth portions of the wireless channel, send a wireless data transmission to the further wireless communication device. The transmission bandwidth of the wireless data transmission is selectively punctured based on the estimated one or more reception conditions.

According to a further embodiment, a computer program or computer program product is provided, e.g., in the form of a non-transitory storage medium, which comprises program code to be executed by at least one processor of a wireless communication device is provided. Execution of the program code causes the wireless communication device to determine one or more idle bandwidth portions of a wireless channel. Further, execution of the program code causes the wireless communication device to, using a transmission bandwidth in the one or more idle bandwidth portions of the wireless channel, receive a wireless data transmission from a further wireless communication device. The transmission bandwidth of the wireless data transmission is selectively punctured based on one or more reception conditions at the wireless communication device.

Details of such embodiments and further embodiments will be apparent from the following detailed description.

### BRIEF DESCRIPTION OF THE DRAWINGS

FIG. 1 schematically illustrates a wireless communication system according to an embodiment.

FIG. 2 schematically illustrates an example of a scenario involving selective puncturing of a wireless channel according to an embodiment.

FIG. 3A illustrates an example of reception conditions as considered in selective puncturing according to an embodiment.

FIG. 3B shows a table with examples of various possible adaptations depending on reception conditions.

FIG. 4A schematically illustrates an example of processes involving selective puncturing according to an embodiment.

FIG. 4B schematically illustrates a further example of processes involving selective puncturing according to an embodiment.

FIG. 5 schematically illustrates a further example of a scenario involving selective puncturing of a wireless channel according to an embodiment.

FIG. 6 shows a flowchart for schematically illustrating a method according to an embodiment.

FIG. 7 shows a block diagram for schematically illustrating functionalities of a wireless communication device according to an embodiment.

FIG. 8 shows a flowchart for schematically illustrating a further method according to an embodiment.

FIG. 9 shows a block diagram for schematically illustrating functionalities of a further wireless communication device according to an embodiment.

FIG. 10 schematically illustrates structures of an AP according to an embodiment.

FIG. 11 schematically illustrates structures of a STA according to an embodiment.

### DETAILED DESCRIPTION

In the following, concepts in accordance with exemplary embodiments of the invention will be explained in more detail and with reference to the accompanying drawings. The illustrated embodiments relate to controlling of wireless transmissions in a wireless communication system. The wireless communication system may be a WLAN system based on a IEEE 802.11 technology. However, it is noted that the illustrated concepts could also be applied to other wireless communication technologies, e.g., to contention-based modes of the LTE (Long Term Evolution) or NR (New Radio) technology specified by 3GPP (3rd Generation Partnership Project).

According to the illustrated concepts, a transmitting wireless communication device may adapt its wireless data transmission based on reception conditions at the intended receiving wireless communication device. The adaptation specifically involves puncturing one or more bandwidth portions of the transmission bandwidth, even though the one or more bandwidth portions were assessed as being idle. Accordingly, the selective puncturing of the illustrated concepts goes beyond puncturing bandwidth portions which, e.g., in an LBT procedure or other carrier sensing mechanism, were assessed as being busy. The puncturing of a bandwidth portion means that the bandwidth portion is left unused in the wireless data transmission, e.g., by avoiding mapping of data to the punctured bandwidth portion. For example, when the wireless data transmission is based on OFDM (Orthogonal Frequency Division Multiplexing), subcarriers in the punctured bandwidth portion could be excluded in the mapping of the data.

The reception conditions considered as a basis for the selective puncturing may include an estimate of resultant signal-to-noise ratio (SNR) at the intended receiving wireless communication device, an estimate of the resultant signal-to-interference-plus-noise ratio (SINR) at the intended receiving wireless communication device, or an estimate of the resultant signal-to-interference ratio (SIR) at the intended receiving wireless communication device. The SNR, SINR, and/or SIR may be estimated and considered individually for different idle portion(s) of the bandwidth. Further, the reception conditions considered as a basis for the selective puncturing may also include an estimated duration of interference at the intended receiving wireless communication device.

The estimation of the reception conditions may be based on information shared by the intended receiving wireless communication device. For example, the intended receiving wireless communication device could perform measurements of SNR, SINR, or SIR and/or estimate an expected duration of interference. Such measurements and estimations may be performed individually for different idle portion(s) of the bandwidth. The intended receiving wireless communication device can then report such information to the transmitting wireless communication device, to be used as input for controlling the selective puncturing at the transmitting wireless communication device. The shared information may be conveyed in a control message, e.g., a control frame, which is sent immediately before the wireless data transmission. In this way, the selective puncturing can be adapted in a dynamic fashion. The control message could for example be a CTS frame or a trigger frame.

In the assumed underlying WLAN scenario, the transmitting wireless communication device may also be referred to as TX STA, and the intended receiving wireless communication device may be referred to as RX STA. In some scenarios, the TX STA is an AP and the RX STA is a non-AP STA associated to the AP. Alternatively, the RX STA could be an AP and the TX STA a non-AP STA associated to the AP.

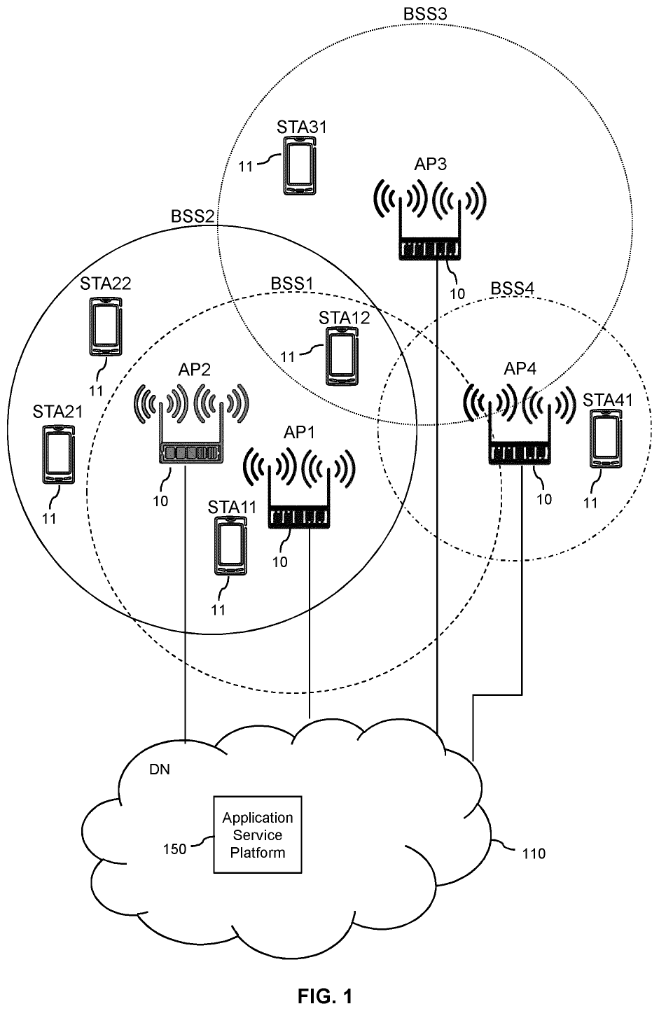

FIG. 1 illustrates an exemplary wireless communication system according to an embodiment. In the illustrated example, the wireless communication system includes multiple APs 10, in the illustrated example referred to as AP1, AP2, AP3, AP4, and multiple stations 11, in the illustrated example referred to as STA11, STA12, STA21, STA22, STA31, and STA41. STA11 and STA 12 are served by AP1 (in a first BSS denoted as BSS1), STA21 and STA22 are served by AP2 (in a second BSS denoted as BSS2), STA31 is served by AP3 (in a third BSS denoted as BSS3), and STA41 is served by AP4 (in a fourth BSS denoted as BSS4). The stations 11 may be non-AP STAs and correspond to various kinds of wireless devices, for example user terminals, such as mobile or stationary computing devices like smartphones, laptop computers, desktop computers, tablet computers, gaming devices, or the like. Further, the stations 11 could for example correspond to other kinds of equipment like smart home devices, printers, multimedia devices, data storage devices, or the like.

In the example of FIG. 1, each of the stations 11 may connect through a radio link to one of the APs 10. For example depending on location or channel conditions experienced by a given station 11, the station 11 may select an appropriate AP 10 and BSS for establishing the radio link. The radio link may be based on one or more OFDM carriers from a frequency spectrum which is shared on the basis of a contention based mechanism, e.g., an unlicensed or license-exempt band like the 2.4 GHz ISM band, the 5 GHz band, the 6 GHz band, or the 60 GHZ band.

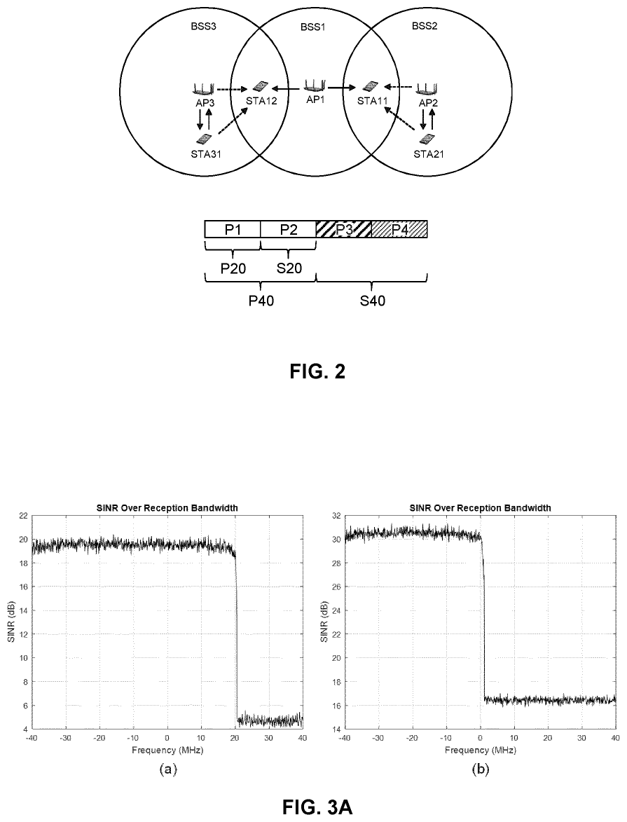

Each AP 10 may provide data connectivity of the stations 11 connected to the AP 10. As further illustrated, the APs 10 may be connected to a data network (DN) 110. In this way, the APs 10 may also provide data connectivity between stations 11 connected to different APs 10. Further, the APs 10 may also provide data connectivity of the stations 11 to other entities, e.g., to one or more servers, service providers, data sources, data sinks, user terminals, or the like. Accordingly, the radio link established between a given station 11 and its serving AP 10 may be used for providing various kinds of services to the station 11, e.g., a voice service, a multimedia service, or other data service. Such services may be based on applications which are executed on the station 11 and/or on a device linked to the station 11. By way of example, FIG. 2 illustrates an application service platform 150 provided in the DN 110. The application(s) executed on the station 11 and/or on one or more other devices linked to the station 11 may use the radio link for data communication with one or more other stations 11 and/or the application service platform 150, thereby enabling utilization of the corresponding service(s) at the station 11.

FIG. 2 schematically illustrates an exemplary scenario in which the selective puncturing of the illustrated concepts is applied. The scenario of FIG. 2 corresponds to a multi-BSS scenario with overlapping operating channels. In particular, the scenario of FIG. 2 assumes three BSS, denoted as BSS1, BSS2, and BSS3. BSS1 is served by AP1, BSS2 is served by AP2, and BSS3 is served by AP3. STA11 and STA12 are served by AP1, with STA11 being located in an overlap region of BSS1 and BSS2 and STA12 being located in an overlap region of BSS1 and BSS3. STA21 is served by AP2, and STA31 is served by AP3. The lower part of FIG. 2 schematically illustrates the allocation of operating channels assumed in the scenario of FIG. 2: BSS1 operates over 80 MHz bandwidth using 20 MHz subchannels P1, P2, P3, and P4, with P1 being the primary subchannel. BSS2 operates over 20 MHz bandwidth using subchannel P4. BSS3 operates over 40 MHz bandwidth, using subchannels P3 and P4. The BSSs, APs, and STAs illustrated in FIG. 2 may for example correspond to the BSSs, APs 10, and stations 11 illustrated in FIG. 1.

In the scenario of FIG. 2, downlink (DL) transmission from AP1 to STA11 may suffer from interference over 20 MHz out of its 80 MHz operating bandwidth due to the transmissions in BSS2. Similarly, DL transmission from AP1 to STA12 may suffer from interference over 40 MHz out of its 80 MHz operating bandwidth due to the transmissions in BSS3. Thus, it can be noted that STA11 and STA12 may be regarded as suffering from a hidden node problem in the sense that AP1 is not able to detect ongoing DL transmissions in BSS2 to STA21 and ongoing DL transmissions in BSS3 to STA31. Due to the overlap of the BSSs such ongoing transmissions may however cause problems for its DL transmissions to STA11 and STA12. As the interfering transmissions from BSS2 or BSS3 do not involve the primary 20 MHZ subchannel of BSS1, the NAVs at STA11 or STA12 are not set by these transmissions. Thus, in the scenario FIG. 2, the NAV based virtual carrier sensing mechanism would not protect STA11 and STA12 in BSS1 from inter-BSS interference.

To address the above-mentioned potential hidden node problem, AP1 could use an RTS/CTS frame exchange prior to sending a DL data transmission to STA11 and STA12. Further, AP1 could use dynamic bandwidth operation as well as preamble puncturing. In such case, upon receiving an RTS frame from AP1, if STA11 is able to detect the interference from BSS2 at or above the ED or PD thresholds, it will indicate in the CTS frame to AP1 corresponding subchannel availability information, i.e., an indication of the subchannel(s) being idle or busy. Similarly, upon receiving an RTS frame from AP1, if STA12 is able to detect the interference from BSS3 at or above the ED or PD thresholds, it will indicate in the CTS frame to AP1 corresponding subchannel availability information, i.e., an indication of the subchannel(s) being idle or busy. Based on the indicated subchannel availability information, AP1 can adapt its transmission bandwidth. However, if the interference levels are below the ED and PD thresholds, all subchannels would be indicated as being idle, and AP1 would thus set the transmission bandwidth to cover the entire 80 MHz operating channel, irrespective of the present interference.

If AP1 would perform its DL data frame transmissions to STA11 or STA12 without further knowledge of the interference conditions at STA11 and STA12, this may for example result in failure of the MCS (Modulation and Coding Scheme) chosen by the LA (Link Adaptation) algorithm at AP1, i.e., failure of successful decoding of the DL data frame transmission based on the chosen MCS, and consequently reception failures and a need of re-transmissions. Here, it should also be noted that, since the MCS selected by AP1 is applied for the entire transmission bandwidth, the appropriate selection of an MCS may be rather sensitive to the presence of interference on a certain subchannel. If for example interference is present on only a 20 MHz subchannel of 80 MHz transmission bandwidth, a rather robust MCS may need to be selected in order to ensure successful reception. However, if this 20 MHz subchannel would be excluded from the transmission bandwidth, the remaining transmission bandwidth would be interference free and a more powerful MCS can be used. The use of the more powerful MCS may in turn outweigh a loss of performance due to the reduced transmission bandwidth. The selective puncturing of the illustrated concepts allows to benefit from such kind of tradeoff, by selectively puncturing one or more idle bandwidth portion(s) depending on the estimated reception conditions. By considering the estimated reception conditions in addition to the information that the bandwidth portion is idle, the TX STA, in the example of FIG. 2 AP1, can further optimize the performance. For example, the TX STA can avoid those portions of the idle bandwidth that may suffer from excessive interference, e.g., have an SNR or SINR below a threshold or have an interference level which is significantly higher than other idle bandwidth portions. For example, if on a certain idle subchannel the level of interference exceeds the average level of interference over all subchannels by a factor of two or more, the subchannel could be excluded by selective puncturing. In some scenarios, the decision whether or not to exclude an idle bandwidth portion by selective puncturing can also be based on an optimization algorithm. For such optimization algorithm, the achievable throughput can be used as performance metric. However, other performance metrics could be used as well. In such optimization algorithm, also the selection of MCS and/or adjustment of transmit power may be considered. For example, when excluding a certain idle bandwidth portion by selective puncturing, there may be a reduced average level of interference over the remaining idle bandwidth portions which allows for using a less robust MCS offering a higher data rate and/or for using a lower transmit power. The lower transmit power may in turn result in reduced generated interference and/or more energy efficient operation. In some cases, the TX STA could however also decide to refrain from applying selective puncturing to an idle bandwidth portion affected by interference and rather decide to select a more robust MCS and/or a higher transmit power.

When deciding on the selective puncturing of one or more idle bandwidth portions, the TX STA may consider the levels of interference on different idle bandwidth portion in terms of SNR or in terms of SINR. For example, the TX STA may obtain an estimate of the resultant average SNR at the intended RX STA. Further, the TX STA can obtain a respective estimate of the resultant SINR at the intended RX STA for each of different idle bandwidth portions, e.g., for each of different idle subchannels. If the estimated average SNR is relatively low, e.g., because the intended RX STA is rather far away from the TX STA and if there is additional interference at the intended RX STA in some of the idle bandwidth portions, as indicated by the respective SINR estimates, the TX STA may adapt the corresponding data frame transmission by applying selective puncturing to the idle bandwidth portions suffering from interference. If in turn the estimated average SNR is relatively high, e.g., because the intended RX STA is close to the TX STA, the TX STA may refrain from applying the selective puncturing and rather adapt the corresponding data frame transmission by using more robust MCS.

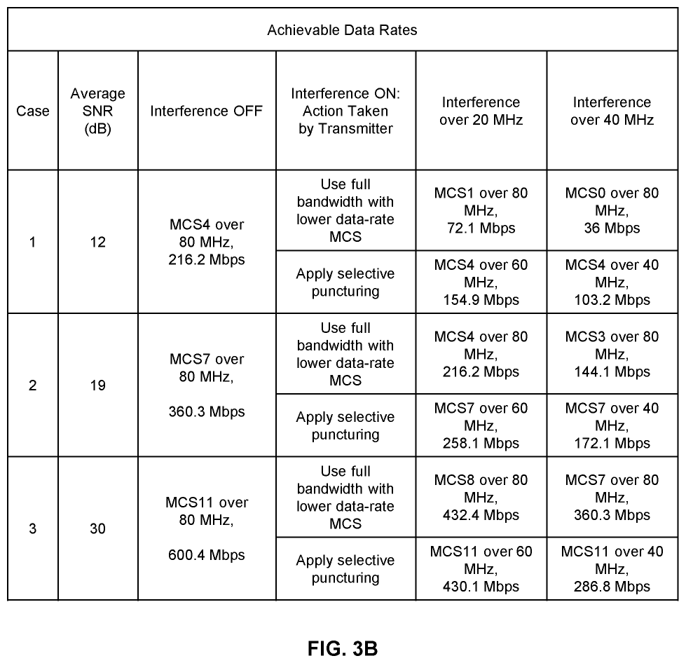

FIGS. 3(a) and 3(b) show exemplary dependencies of SINR on frequency to illustrate how different decisions and actions that can be taken by the TX STA with respect to the selective puncturing of the illustrated concepts. When considering the scenario of FIG. 2, STA11, which operates over 80 MHz bandwidth, which were assessed to be idle, may suffer from interference from BSS2 in the 20 MHz portion which overlaps with BSS2, i.e., subchannel P4. This may result in the estimated SINR at STA11 over its available reception bandwidth being like illustrated in FIG. 3(a). FIG. 3(a) shows the SINR at STA11 in the overlapping 20 MHz portion to be approximately 15 dB worse than that in the non-overlapping portion of the bandwidth. It should be noted that the SINR values of FIG. 3(a) are merely an example, and the SINR variation over frequency at STA11 may for example look different at another time instance, depending on variations of the propagation channel conditions, and also depending on characteristics of interference, such as bandwidth, power, spectral mask, or the like. The characteristics of the interference may for example differ depending on whether the source of interference is a Wi-Fi signal or a non-Wi-Fi signal. FIG. 3(b) shows another example of an estimated SINR variation over the available reception bandwidth, this time at STA12 which also operates over 80 MHz bandwidth, and which may suffer from interference from BSS3 in the 40 MHz portion which overlaps with BSS3, i.e., subchannels P3 and P4 in the scenario of FIG. 2.

When assuming reception conditions like illustrated by FIG. 3, if AP1 would perform its data frame transmissions to STA11 and STA 12 without selective puncturing based on the estimated reception conditions, the data frame transmissions could be inefficient or even fail. However, by applying the selective puncturing based on the estimated reception conditions, efficiency can be improved and failure avoided.

FIG. 3B shows a table with various adaptations performed by the TX STA and resulting achievable data rates. The values in the table of FIG. 3B are based on link-level simulations, assuming that the TX STA would attempt to undertake data frame transmissions using an 80 MHz operating bandwidth (with 0.8 us guard interval) and that interference may occur in some portions of the operating bandwidth, however with these bandwidth portions still being assessed as idle. Out of the three cases listed in the table, it can be seen that applying the selective puncturing by avoiding transmitting in the bandwidth portion(s) affected by interference results in the highest achievable data rate in Cases 1 and 2, which correspond to relatively low SNRs. As compared to that, using the full bandwidth with a lower data-rate MCS results in the highest achievable data rate in Case 3, which corresponds to a higher average SNR. The selective puncturing thus tends to provide higher gain in the achievable data rate as the average SNR decreases.

Further, it is noted that, if the wireless communication system is power limited, e.g., limited with respect to EIRP (Effective Isotropic Radiated Power) and not PSD (Power Spectral Density) limited, applying selective puncturing can be expected to provide further gains since the link quality, e.g., in terms of SNR, would improve due to the same amount of power being transmitted over a smaller bandwidth. For example, if the total transmit power is kept constant, reducing the transmission bandwidth by half would lead to a 3 dB higher SNR at the intended receiver. This might then allow the transmitter to use a higher data-rate MCS over the reduced bandwidth when compared to the MCS that it may be able to use over the full bandwidth when interference is absent. When for example considering a scenario in which the average SNR at the TX STA when receiving over 80 MHz bandwidth is 16 dB and the system is power limited, link-level simulations show that if the transmit power is kept constant, MCS5 can be successfully received over 80 MHz bandwidth, MCS6 can be successfully received over 40 MHz bandwidth, and MCS7 can be successfully received over 20 MHz bandwidth. With such behavior, selective puncturing may provide gains even for higher average SNR. This can be attributed to the average SNR improving as the bandwidth decreases.

In some scenarios, the TX STA may also adapt its data frame transmission based on an estimated duration of interference at the intended RX STA. For example, the TX STA may apply the selective puncturing only when the estimated duration of the interference is sufficiently long, e.g., of substantially the same duration as the duration of the data frame transmission or even longer.

The TX STA may be able to acquire information on the receiver conditions, such as expected presence, level and/or duration of interference, by measurements performed by the TX STA itself. In addition or as an alternative, the TX STA may acquire information on the receiver conditions with assistance from the intended RX STA. The latter variant may be useful in hidden node scenarios, e.g., as illustrated with respect to AP1 in FIG. 2.

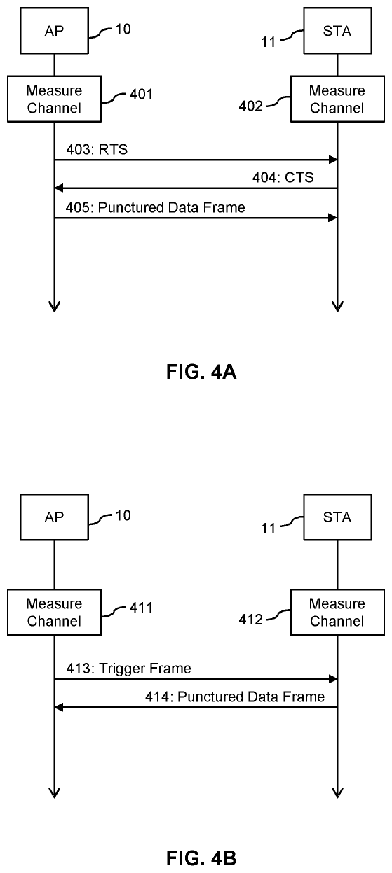

FIGS. 4A and 4B show examples of processes in which the intended RX STA assists the TX STA in estimating the reception conditions at the RX STA. In each case, the processes involve an AP 10 and a STA 11 associated with the AP 10.

In the example of FIG. 4A, the AP 10 is the TX STA and the STA 11 is the RX STA. As illustrated by blocks 401 and 402, both the AP 10 and the STA 11 initially measure the wireless channel.

This is typically done over the entire operating bandwidth. As a result, the AP 10 and the STA 11 determine which bandwidth portions, e.g., subchannels, of the operating bandwidth are idle. Further, the AP 10 and the STA 11 also determine the channel conditions on the idle bandwidth portions, e.g., average SNR over all idle bandwidth portions and SINR per bandwidth portion. Based on the bandwidth portions assessed as being idle, the AP 10 determines the transmission bandwidth to be used for sending a data frame to the STA 11. For example, if not all bandwidth portions of the operating bandwidth were assessed as being idle, the AP 10 may determine the transmission bandwidth as the combination of the idle bandwidth portions, e.g., using preamble puncturing and/or dynamic bandwidth operation.

As further illustrated, before sending the data frame, the AP 10 sends an RTS frame 403 to the STA 11, and the STA 11 responds with a CTS frame 404. By means of the RTS frame 403 and the CTS frame 404, the AP 10 and the STA 11 may exchange information on the bandwidth portions assessed as being idle. This may help to address some hidden node problems. For example, if the AP 10 assessed a certain bandwidth portion as being idle, but the STA 11 assessed this bandwidth portion as being occupied, the STA 11 may indicate its assessment to the AP 10, and the AP 10 may adjust its assessment accordingly.

Further, the STA 11 uses the CTS frame 404 to indicate reception conditions as measured at block 402, in particular the average SNR over the idle bandwidth portions and the SINR per idle bandwidth portions. Further, the STA 11 may include information on an expected duration of interference into the CTS frame 404.

Based on the reception conditions at the STA 11 as estimated from the information included in the CTS frame 404, in particular the average SNR and the SINRs per idle bandwidth portion, and in some cases also the expected duration of interference, the AP 10 decides to apply selective puncturing to at least one of the idle bandwidth portions. As illustrated, the AP 10 then sends a correspondingly punctured data frame 405 to the STA 11.

In the example of FIG. 4B, the STA 11 is the TX STA and the AP 10 is the RX STA. As illustrated by blocks 411 and 412, both the AP 10 and the STA 11 initially measure the wireless channel. This is typically done over the entire operating bandwidth. As a result, the AP 10 and the STA 11 determine which bandwidth portions, e.g., subchannels, of the operating bandwidth are idle. Further, the AP 10 and the STA 11 also determine the channel conditions on the idle bandwidth portions, e.g., average SNR over all idle bandwidth portions and SINR per bandwidth portion. Based on the bandwidth portions assessed as being idle, the STA 11 determines the transmission bandwidth to be used for sending a data frame to the AP 10. For example, if not all bandwidth portions of the operating bandwidth were assessed as being idle, the STA 11 may determine the transmission bandwidth as the combination of the idle bandwidth portions, e.g., using preamble puncturing and/or dynamic bandwidth operation.

As further illustrated, to trigger transmission of the data frame, the AP 10 sends a trigger frame 413 to the STA 11. The AP 10 may use the trigger frame 413 to indicate reception conditions as measured at block 411, in particular the average SNR over the idle bandwidth portions and the SINR per idle bandwidth portions. Further, the AP 10 may include information on an expected duration of interference into the trigger frame 413.

Based on the reception conditions at the AP 10 as estimated from the information included in the trigger frame 413, in particular the average SNR and the SINRs per idle bandwidth portion, and in some cases also the expected duration of interference, the STA 11 decides to apply selective puncturing to at least one of the idle bandwidth portions. As illustrated, in response to the trigger frame 413, the STA 11 then sends a correspondingly punctured data frame 414 to the AP 10.

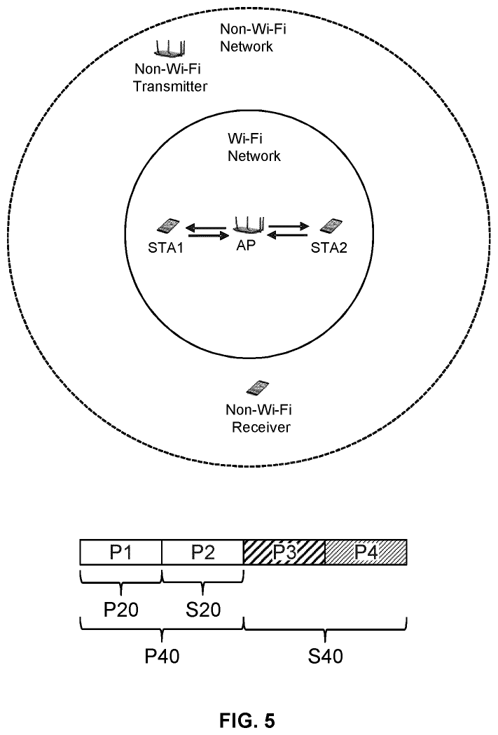

In some scenarios, the TX STA may also autonomously estimate the reception conditions at the intended RX STA. FIG. 5 illustrates an example of a corresponding scenario. The scenario of FIG. 5 assumes a Wi-Fi network co-located with a non-Wi-Fi network. In the scenario of FIG. 5, the Wi-Fi network may suffer from interference over 40 MHz within its total 80 MHz operating bandwidth due the transmissions in the non-Wi-Fi network. In FIG. 5, the Wi-Fi transmitters (both AP and STAs) may be able to estimate the presence of the interference resulting from transmissions in the non-Wi-Fi network without requiring any assistance from the intended RX STAs, by measurements performed by the respective TX STA itself. For this purpose, the APs and STAs of the Wi-Fi network may use the ED threshold based carrier sensing mechanism. The ED threshold can be 30 dB above the actual minimum receiver sensitivity level, which means that even if the carrier sensing based on the ED threshold yields a bandwidth portion as being idle, there may be relevant interference below that threshold. As a result, the performance of the Wi-Fi network could be severely degraded. This may be avoided by the TX STA of the Wi-Fi network performing measurements to estimate the reception conditions on the idle bandwidth portions, e.g., by measuring average SNR and SINR per idle bandwidth portion, and using these estimates to decide whether and which idle bandwidth portions should be subjected to selective puncturing. Even though the measurements are performed by the TX STA, the measurements may still enable a reasonably accurate estimation, e.g., based on a channel reciprocity assumption.

As can be taken from the above, one functionality of the RX STA in the illustrated concepts is to assist the TX STA in the estimation of the reception conditions at the RX STA. Further, the RX STA needs to be capable of receiving the data frame transmission from the TX STA, irrespective of the applied selective puncturing.

Accordingly, an intended RX STA may share information about the estimated reception conditions at the RX STA with the TX STA. This information may be specific with respect to different idle bandwidth portions of the operating bandwidth of the RX STA, or different portions of the available reception bandwidth of the RX STA. The intended RX STA may include the information to be shared into a control frame which is preferably sent immediately preceding the intended data frame transmission. Based on the shared information, the TX STA transmitter can adapt the data frame transmission appropriately to improve the probability of successful reception, efficiency, and/or performance. The control frame can be a CTS frame or a trigger frame. Usage of a control frame sent immediately preceding the data frame transmission may allow for better accommodating dynamically varying interference conditions.

The information shared by the intended RX STA may be based on the estimated SINR in the different idle bandwidth portions of the reception bandwidth. The shared information may indicate that the SINR in some idle bandwidth portion(s) is worse than in one or more other idle bandwidth portion(s). In some scenarios, the information shared by the intended RX STA may be based on the estimated interference-plus-noise power in the different idle bandwidth portions of the reception bandwidth. The shared information may then indicate that the interference-plus-noise power in some idle bandwidth portion(s) of the reception bandwidth is worse than in one or more other idle bandwidth portion(s).

An intended RX STA may sometimes suffer from interference over a large part of its operating bandwidth. In such cases, upon receiving information shared by the intended RX STA in a control frame immediately preceding a data frame, the TX STA may rather suspend the corresponding data frame transmission attempt to that intended RX STA and for example perform another data transmission attempt to another STA. When applied by an AP, this may help to optimize overall performance of the AP's BSS.

The information shared by the intended RX STA may be indicated with a frequency granularity of 20 MHz. That is to say, the different idle bandwidth portions may have a size of 20 MHz or a size corresponding to an integer multiple of 20 MHz. This may be beneficial because in the IEEE 802.11 Standard the CCA resolution in IEEE 802.11 is 20 MHz. Accordingly, IEEE 802.11 Standard compliant STAs have the capability of assessing the reception conditions with at least a granularity of 20 MHz. In some cases, a channel puncturing bitmap may be used by the RX STA to indicate which bandwidth portions are idle and, based on the estimated reception conditions at the intended RX STA, are suggested to be used in the data frame transmission. For example, in such channel puncturing bitmap a bit set to “1” could indicate a subchannel which is idle and shall be used in the data frame transmission, and a bit set to “0” could indicate a subchannel which is either not idle or idle but shall be selectively punctured due to the estimated reception conditions on that subchannel. The channel puncturing bitmap could thus for example highlight the good and bad 20 MHz subchannels based upon the difference in their respective SINRs. In some scenarios, the shared information about different idle bandwidth portions of the reception bandwidth could also have a granularity of lower than 20 MHZ, e.g., a granularity corresponding to sizes of RUs (Resource Units) supported by the RX STA, e.g., corresponding to a 52-tone RU of about 4 MHz or corresponding to a 26-tone RU of about 2 MHz.

As an example corresponding to the scenario depicted in FIG. 2, STA11 and STA12 may share information about their respective reception conditions corresponding to every 20 MHZ subchannel in their assessed available reception bandwidths. This information can then help AP1 to appropriately adapt its data frame transmissions, by deciding based on the shared information whether and which idle subchannels should be excluded by the selective puncturing.

In some scenarios, the information shared by the intended RX STA in a CTS frame may be based on the estimated duration of interference, e.g., by comparing the duration of a detected interfering signal to the duration of a TXOP reserved by the received RTS frame. As an example, corresponding to the scenario depicted in FIG. 2, if an interfering signal from BSS2 is detected by STA11 and is below the PD threshold and at or above its minimum receiver sensitivity level, STA11 may estimate the duration of the interference by reading the frame length indicated in the PHY header (preamble) of that signal and/or by reading the duration value from a MAC header. If the corresponding estimated duration is close to or longer than the TXOP duration being reserved by AP1 using a RTS frame that it sends to STA11, STA11 can deduce that it would suffer from that interference for the entire TXOP duration. In such a scenario, it would be clearly beneficial for STA11 to leverage the CTS frame and convey information to AP1 about the interference situation so that AP1 can take appropriate actions while performing the corresponding data frame transmission.

In some scenarios, the TX STA transmitter can prepare in advance to the case that the intended RX STA could face interference in some portion of the operating bandwidth. For example, the TX STA could prepare in advance a correspondingly punctured data frame as well as a non-punctured data frame with the same data content. Based on the reception conditions estimated just before the intended data frame transmission, e.g., as estimated from the control frame, the TX STA may the decide whether to transmit the punctured data frame or the non-punctured data frame.

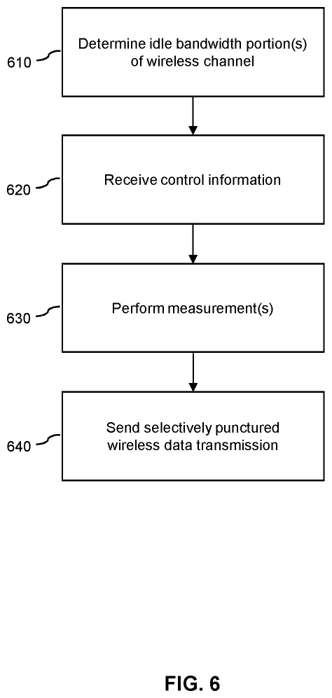

FIG. 6 shows a flowchart for illustrating a method of controlling wireless transmissions in a wireless communication system, which may be utilized for implementing the illustrated concepts. The method of FIG. 6 may be used for implementing the illustrated concepts in a wireless communication device which intends to send a wireless data transmission to a further wireless communication device. The wireless communication device and the further wireless communication device may for example correspond to the above-mentioned TX STA and intended RX STA, respectively. The wireless communication system may be based on a wireless local area network, WLAN, technology, e.g., according to the IEEE 802.11 standards family. The wireless communication device may correspond to an AP, e.g., one of the above-mentioned APs 10, or to a non-AP STA, e.g., one of the above-mentioned STAs 11.

If a processor-based implementation of the wireless communication device is used, at least some of the steps of the method of FIG. 6 may be performed and/or controlled by one or more processors of the wireless communication device. Such wireless communication device may also include a memory storing program code for implementing at least some of the below described functionalities or steps of the method of FIG. 6.

At step 610, the wireless communication device determines one or more idle bandwidth portions of a wireless channel. This determination may be based on various types of LBT or CCA procedure, e.g., on CCA using an ED threshold, virtual carrier sensing based on NAV or CCA using a PD threshold. The idle bandwidth portion(s) may be determined with a certain granularity in the frequency domain. For example, step 610 may involve that for each subchannel of the wireless channel, e.g., of 20 MHz bandwidth, it is determined whether the subchannel is idle or busy.

At step 620, the wireless communication device may receive control information from the further wireless communication device. The control information may for example be received in a control frame immediately preceding the wireless data transmission. For example, the wireless communication device may receive the control information in a CTS frame transmitted by the further wireless communication device, e.g., as explained in connection with FIG. 4A. Alternatively, the wireless communication device could receive the control information in a trigger message transmitted by the further wireless communication device to trigger the wireless data transmission, e.g., in a trigger frame as explained in connection with FIG. 4B.

In some scenarios, the control information includes an SNR estimated by the further wireless communication device. Alternatively or in addition, the control information may include an SINR estimated by the further wireless communication device. Alternatively or in addition, the control information may include an SIR estimated by the further wireless communication device. Alternatively or in addition, the control information may include a duration of interference estimated by the further wireless communication device. In some scenarios, the control information may be determined individually for each of the one or more idle bandwidth portions. In some scenarios, the control information indicates the idle bandwidth portion.

In some scenarios, the wireless communication device may perform one or more measurements on the wireless channel and estimate the one or more reception conditions based on the one or more measurements.

The one or more reception conditions may include an SNR. Alternatively or in addition, the one or more reception conditions may include an SINR. Alternatively or in addition, the one or more reception conditions may include an SIR. Alternatively or in addition, the one or more reception conditions may include a duration of interference. In some scenarios, the one or more reception conditions may be determined individually for each of the one or more idle bandwidth portions.

At step 630, the wireless communication device estimates one or more reception conditions at the further wireless communication device. The estimation of step 630 may be based on the control information received at step 620.

At step 640, the wireless communication device sends the wireless data transmission to the further wireless communication device. This is accomplished using a transmission bandwidth in the idle bandwidth portion(s) of the wireless channel. The transmission bandwidth of the wireless data transmission is selectively punctured based on the one or more reception conditions estimated at step 630. In some scenarios, step 640 may also involve that based on the one or more reception conditions estimated at step 630 the wireless communication device decides whether to selectively puncture the transmission bandwidth. In some scenarios, step 640 may also involve that based on the one or more reception conditions estimated at step 630 the wireless communication device decides whether to suspend the wireless data transmission and, in response to deciding not to suspend the wireless data transmission, the wireless communication device sends the wireless data transmission to the further wireless communication device. In some scenarios, step 640 may also involve that the wireless communication device adapts an MCS of the wireless data transmission and/or transmit power of the wireless data transmission. This adaptation may be based on the one or more reception conditions estimated at step 630.

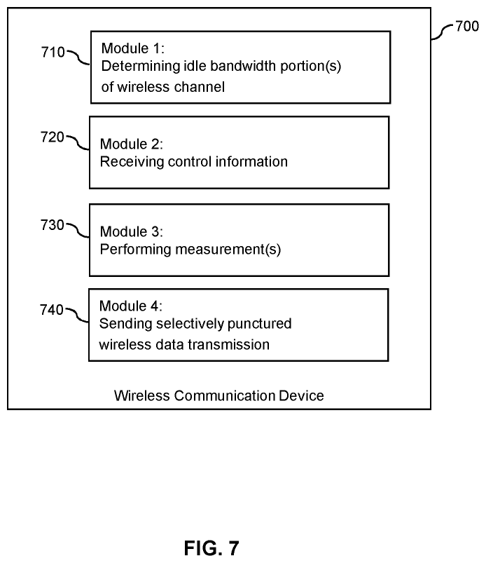

FIG. 7 shows a block diagram for illustrating functionalities of a wireless communication device 700 which operates according to the method of FIG. 6. The wireless communication device may correspond to an AP, e.g., one of the above-mentioned APs 10, or to a non-AP STA, e.g., one of the above-mentioned STAs 11. As illustrated, the wireless communication device 700 may be provided with a module 710 configured to determine one or more idle bandwidth portions of a wireless channel, such as explained in connection with step 610. Further, the wireless communication device 700 may be provided with a module 720 configured to receive control information, such as explained in connection with step 620. Further, the wireless communication device 700 may be provided with a module 730 configured to estimate one or more reception conditions, such as explained in connection with step 630. Further, the wireless communication device 700 may be provided with a module 740 configured to send a selectively punctured wireless data transmission, such as explained in connection with step 640.

It is noted that the wireless communication device 700 may include further modules for implementing other functionalities, such as known functionalities of an AP or non-AP STA in an IEEE 802.11 technology. Further, it is noted that the modules of the wireless communication device 700 do not necessarily represent a hardware structure of the wireless communication device 700, but may also correspond to functional elements, e.g., implemented by hardware, software, or a combination thereof.

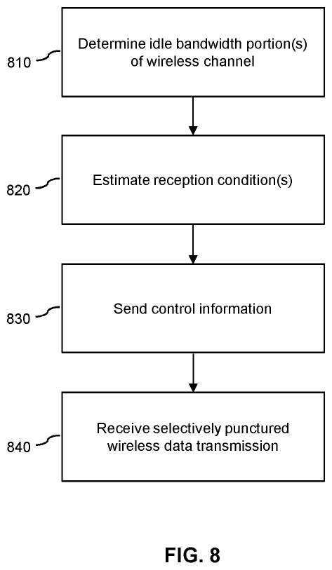

FIG. 8 shows a flowchart for illustrating a further method of controlling wireless transmissions in a wireless communication system, which may be utilized for implementing the illustrated concepts. The method of FIG. 8 may be used for implementing the illustrated concepts in a wireless communication device which is an intended receiver of a wireless data transmission from a further wireless communication device. The wireless communication device and the further wireless communication device may for example correspond to the above-mentioned intended RX STA and TX STA, respectively. The wireless communication system may be based on a wireless local area network, WLAN, technology, e.g., according to the IEEE 802.11 standards family. The wireless communication device may correspond to an AP, e.g., one of the above-mentioned APs 10, or to a non-AP STA, e.g., one of the above-mentioned STAs 11.

If a processor-based implementation of the wireless communication device is used, at least some of the steps of the method of FIG. 8 may be performed and/or controlled by one or more processors of the wireless communication device. Such wireless communication device may also include a memory storing program code for implementing at least some of the below described functionalities or steps of the method of FIG. 8.

At step 810, the wireless communication device determines one or more idle bandwidth portions of a wireless channel. This determination may be based on various types of LBT or CCA procedure, e.g., on CCA using an ED threshold, virtual carrier sensing based on NAV or CCA using a PD threshold. The idle bandwidth portion(s) may be determined with a certain granularity in the frequency domain. For example, step 810 may involve that for each subchannel of the wireless channel, e.g., of 20 MHz bandwidth, it is determined whether the subchannel is idle or busy.

At step 820, the wireless communication device estimates one or more reception conditions at the wireless communication device. The one or more reception conditions may include an SNR. Alternatively or in addition, the one or more reception conditions may include an SINR. Alternatively or in addition, the one or more reception conditions may include an SIR. Alternatively or in addition, the one or more reception conditions may include a duration of interference. In some scenarios, the one or more reception conditions may be determined individually for each of multiple parts of the idle bandwidth portion.

In some scenarios, the wireless communication device may perform one or more measurements on the wireless channel and estimate the one or more reception conditions based on the one or more measurements.

At step 830, the wireless communication device may send control information to the further wireless communication device. The control information may for example be sent in a control frame immediately preceding the wireless data transmission. For example, the wireless communication device may send the control information in a CTS frame to the further wireless communication device, e.g., as explained in connection with FIG. 4A. Alternatively, the wireless communication device could send the control information in a trigger message sent to the further wireless communication device to trigger the wireless data transmission, e.g., in a trigger frame as explained in connection with FIG. 4B. The control information may indicate at least a part of the reception conditions estimated at step 820.

At step 840, the wireless communication device receives the wireless data transmission from the further wireless communication device. This is accomplished using a transmission bandwidth in the idle bandwidth portion(s) of the wireless channel. The transmission bandwidth of the wireless data transmission is selectively punctured based on one or more reception conditions at the wireless communication device, e.g., as estimated at step 820. In some scenarios, an MCS and/or a transmit power of the wireless data transmission depends on the one or more reception conditions.

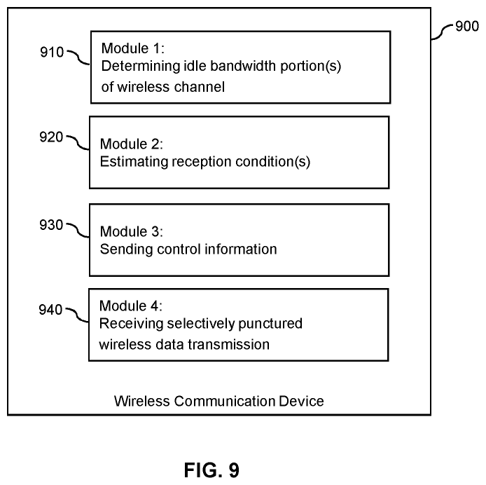

FIG. 9 shows a block diagram for illustrating functionalities of a wireless communication device 900 which operates according to the method of FIG. 8. The wireless communication device may correspond to an AP, e.g., one of the above-mentioned APs 10, or to a non-AP STA, e.g., one of the above-mentioned STAs 11. As illustrated, the wireless communication device 900 may be provided with a module 910 configured to determine an idle bandwidth portion of a wireless channel, such as explained in connection with step 810. Further, the wireless communication device 900 may be provided with a module 920 configured to estimate one or more reception conditions, such as explained in connection with step 820. Further, the wireless communication device 900 may be provided with a module 930 configured to send control information, such as explained in connection with step 830. Further, the wireless communication device 900 may be provided with a module 940 configured to receive a selectively punctured wireless data transmission, such as explained in connection with step 840.

It is noted that the wireless communication device 900 may include further modules for implementing other functionalities, such as known functionalities of an AP or non-AP STA in an IEEE 802.11 technology. Further, it is noted that the modules of the wireless communication device 900 do not necessarily represent a hardware structure of the wireless communication device 900, but may also correspond to functional elements, e.g., implemented by hardware, software, or a combination thereof.

It is noted that the method of FIG. 6 and the method of FIG. 8 could also be combined in a system which includes a transmitting wireless communication device operating according to the method of FIG. 6 and a receiving wireless communication device operating according to the method of FIG. 8. Further, it is noted that the same wireless communication device could operate according to the method of FIG. 6 as a transmitting wireless communication device and according to the method of FIG. 8 as a receiving wireless communication device.

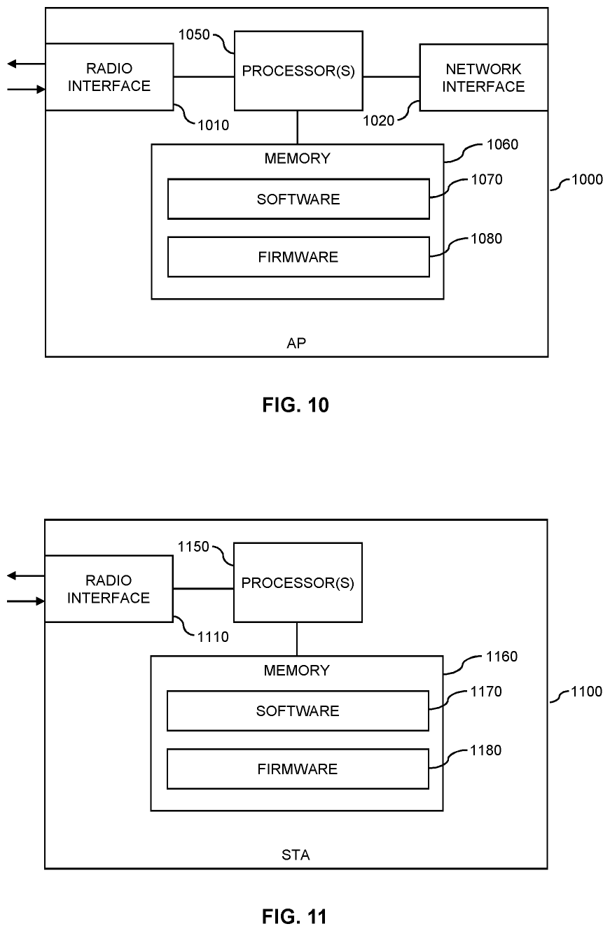

FIG. 10 illustrates a processor-based implementation of an AP 1000. The structures as illustrated in FIG. 10 may be used for implementing the above-described concepts. The AP 1000 may for example correspond to one of above-mentioned APs 10.

As illustrated, the AP 1000 includes a radio interface 1010. The radio interface 1010 may for example be based on a WLAN technology, e.g., according to an IEEE 802.11 family standard. However, other wireless technologies could be supported as well, e.g., the LTE technology or the NR technology. Further, the AP 1000 is provided with a network interface 1020 for connecting to a data network, e.g., using a wire-based connection.

Further, the AP 1000 may include one or more processors 1050 coupled to the interfaces 1010, 1020, and a memory 1060 coupled to the processor(s) 1050. By way of example, the interfaces 1010, 1020, the processor(s) 1050, and the memory 1060 could be coupled by one or more internal bus systems of the AP 1000. The memory 1060 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 1060 may include software 1070 and/or firmware 1080. The memory 1060 may include suitably configured program code to be executed by the processor(s) 1050 so as to implement the above-described functionalities for controlling wireless transmissions, such as explained in connection with the methods of FIG. 6 or 8.

It is to be understood that the structures as illustrated in FIG. 10 are merely schematic and that the AP 1000 may actually include further components which, for the sake of clarity, have not been illustrated, e.g., further interfaces or further processors. Also, it is to be understood that the memory 1060 may include further program code for implementing known functionalities of an AP in an IEEE 802.11 technology. According to some embodiments, also a computer program may be provided for implementing functionalities of the AP 1000, e.g., in the form of a physical medium storing the program code and/or other data to be stored in the memory 1060 or by making the program code available for download or by streaming.

FIG. 11 illustrates a processor-based implementation of a STA 1100. The structures as illustrated in FIG. 11 may be used for implementing the above-described concepts. The STA 1100 may for example correspond to one of above-mentioned STAs 11.

As illustrated, the STA 1100 includes a radio interface 1110. The radio interface 1110 may for example be based on a WLAN technology, e.g., according to an IEEE 802.11 family standard.

However, other wireless technologies could be supported as well, e.g., the LTE technology or the NR technology.

Further, the STA 1100 may include one or more processors 1150 coupled to the interface 1110 and a memory 1160 coupled to the processor(s) 1150. By way of example, the interface 1110, the processor(s) 1150, and the memory 1160 could be coupled by one or more internal bus systems of the STA 1100. The memory 1160 may include a ROM, e.g., a flash ROM, a RAM, e.g., a DRAM or SRAM, a mass storage, e.g., a hard disk or solid state disk, or the like. As illustrated, the memory 1160 may include software 1170 and/or firmware 1180. The memory 1160 may include suitably configured program code to be executed by the processor(s) 1150 so as to implement the above-described functionalities for controlling wireless transmissions, such as explained in connection with the methods of FIG. 6 or 8.

It is to be understood that the structures as illustrated in FIG. 11 are merely schematic and that the STA 1100 may actually include further components which, for the sake of clarity, have not been illustrated, e.g., further interfaces or further processors. Also, it is to be understood that the memory 1160 may include further program code for implementing known functionalities of a non-AP STA in an IEEE 802.11 technology. According to some embodiments, also a computer program may be provided for implementing functionalities of the STA 1100, e.g., in the form of a physical medium storing the program code and/or other data to be stored in the memory 1160 or by making the program code available for download or by streaming.

As can be seen, the concepts as described above may be used for efficiently adapting wireless transmissions with the aim of reliable and efficient wireless transmission of data from a transmitter to a receiver. The probability of successful reception of data may be improved, which helps to reduce a need for retransmissions. This may in turn improve both efficiency and latency. Further, the achievable throughput in the wireless communication system can be optimized.

It is to be understood that the examples and embodiments as explained above are merely illustrative and susceptible to various modifications. For example, the illustrated concepts may be applied in connection with various kinds of wireless technologies, without limitation to WLAN technologies. Further, the concepts may be also be applied with respect to multiple intended receivers of the wireless data transmission. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1.-41. (canceled)

42. A method of controlling wireless transmissions in a wireless communication system, the method comprising:
determining, by a wireless communication device, one or more idle bandwidth portions of a wireless channel;
estimating, by the wireless communication device, one or more reception conditions at a further wireless communication device; and
using a transmission bandwidth in the one or more idle bandwidth portions of the wireless channel, sending, by the wireless communication device, a wireless data transmission to the further wireless communication device, wherein the transmission bandwidth of the wireless data transmission is selectively punctured based on the estimated one or more reception conditions.

43. The method according to claim 42, further comprising receiving, by the wireless communication device, control information from the further wireless communication device, and wherein said estimating comprises estimating, by the wireless communication device, the one or more reception conditions based on the control information received from the further wireless communication device.

44. The method according to claim 43, wherein said receiving comprises:
receiving the control information in a Clear To Send (CTS) frame transmitted by the further wireless communication device; or
receiving the control information in a trigger message transmitted by the further wireless communication device to trigger the wireless data transmission.

45. The method according to claim 43, wherein the control information comprises:
a Signal-to-Noise Ratio (SNR) estimated by the further wireless communication device;
a Signal-to-Interference-plus-Noise Ratio (SINR) estimated by the further wireless communication device;
a Signal-to-Interference Ratio (SIR) estimated by the further wireless communication device; or
a duration of interference estimated by the further wireless communication device.

46. The method according to claim 43, wherein at least a part of the control information is determined individually for each of the one or more idle bandwidth portions.

47. The method according to claim 43, wherein the control information indicates the one or more idle bandwidth portions.

48. The method according to claim 42, further comprising performing, by the wireless communication device, one or more measurements on the wireless channel, and wherein said estimating comprises estimating the one or more reception conditions based on the one or more measurements.

49. The method according to claim 42, wherein the estimated one or more reception conditions comprise an SNR, an SINR, an SIR, or a duration of interference.

50. The method according to claim 42, wherein at least one of the estimated one or more reception conditions is determined individually for each of the one or more idle bandwidth portions.

51. The method according to claim 42, further comprising, based on the estimated one or more reception conditions, adapting, by the wireless communication device:
a Modulation and Coding Scheme (MCS) of the wireless data transmission; and/or
transmit power of the wireless data transmission.

52. The method according to claim 42, further comprising:
based on the estimated one or more reception conditions, deciding, by the wireless communication device, whether to suspend the wireless data transmission; and
in response to deciding not to suspend the wireless data transmission, sending, by the wireless communication device, the wireless data transmission to the further wireless communication device.

53. The method according to claim 42, wherein the wireless communication system is based on a Wireless Local Area Network technology according to the IEEE 802.11 standards family.

54. A method of controlling wireless transmissions in a wireless communication system, the method comprising:
determining, by a wireless communication device, one or more idle bandwidth portions of a wireless channel; and
using a transmission bandwidth in the one or more idle bandwidth portions of the wireless channel, receiving, by the wireless communication device, a wireless data transmission from a further wireless communication device, wherein the transmission bandwidth of the wireless data transmission is selectively punctured based on one or more reception conditions at the wireless communication device.

55. The method according to claim 54, further comprising:
estimating, by the wireless communication device, the one or more reception conditions at the wireless communication device; and
sending, by the wireless communication device, control information to the further wireless communication device, the control information indicating the estimated one or more reception conditions.

56. The method according to claim 55, wherein the wireless communication device sends the control information in:
a CTS frame transmitted to the further wireless communication device; or
a trigger message transmitted to the further wireless communication device to trigger the wireless data transmission.

57. The method according to claim 54, wherein the one or more reception conditions comprise an SNR, an SINR, an SIR, or a duration of interference.

58. The method according to claim 54, wherein at least one of the estimated one or more reception conditions is determined individually for each of the one or more idle bandwidth portions.

59. The method according to claim 54, wherein the control information indicates the idle bandwidth portion.

60. The method according to claim 54, further comprising:
performing, by the wireless communication device, one or more measurements on the wireless channel; and
estimating, by the wireless communication device, the one or more reception conditions based on the one or more measurements.

61. The method according to claim 54, wherein an MCS of the wireless data transmission and/or transmit power of the wireless data transmission depends on the one or more reception conditions.

62. The method according to claim 54, wherein the wireless communication system is based on a Wireless Local Area Network technology according to the IEEE 802.11 standards family.

63. A wireless communication device for a wireless communication system, the wireless communication device comprising:
at least one processor, and
a memory containing program code executable by the at least one processor,
whereby execution of the program code by the at least one processor causes the wireless communication device to:
determine one or more idle bandwidth portions of a wireless channel;
estimate one or more reception conditions at a further wireless communication device; and
using a transmission bandwidth in the one or more idle bandwidth portions of the wireless channel, send a wireless data transmission to the further wireless communication device, wherein the transmission bandwidth of the wireless data transmission is selectively punctured based on the estimated one or more reception conditions.

64. A wireless communication device for a wireless communication system, the wireless communication device comprising:
at least one processor, and
a memory containing program code executable by the at least one processor,
whereby execution of the program code by the at least one processor causes the wireless communication device to:
determine one or more idle bandwidth portions of a wireless channel; and
using a transmission bandwidth in the one or more idle bandwidth portions of the wireless channel, receive a wireless data transmission from a further wireless communication device, wherein the transmission bandwidth of the wireless data transmission is selectively punctured based on one or more reception conditions at the wireless communication device.

65. A non-transitory computer-readable storage medium on which is stored program code to be executed by at least one processor of a wireless communication device, whereby execution of the program code causes the wireless communication device to perform a method according to claim 42.

66. A non-transitory computer-readable storage medium on which is stored program code to be executed by at least one processor of a wireless communication device, whereby execution of the program code causes the wireless communication device to perform a method according to claim 54.
